(19) United States
(12) Patent Application Publication
(10) Pub. No.: US 2013/0107221 A1
(43) Pub. Date: May 2, 2013

(54) LIGHT EMITTING MODULE AND DISPLAY DEVICE

(71) Applicants: Chi-Hsuan HSU, Taoyuan Hsien (TW); Yao-Hsien HUANG, Taoyuan Hsien (TW)

(72) Inventors: Chi-Hsuan HSU, Taoyuan Hsien (TW); Yao-Hsien HUANG, Taoyuan Hsien (TW)

(73) Assignee: DELTA ELECTRONICS, INC., Taoyuan Hsien (TW)

(21) Appl. No.: 13/372,948

(22) Filed: Feb. 14, 2012

(30) Foreign Application Priority Data
Oct. 31, 2011 (TW) 100139497

(51) Int. Cl. G03B 21/14; F21V 9/00; H05B 37/02

(52) U.S. Cl. 353/31; 315/291; 362/231

(57) ABSTRACT

A light emitting module and a display device comprising the light emitting module are provided. The light emitting module comprises an excitation light source, a phosphor wheel and a driving circuit. The excitation light source is configured to generate an excitation light. The phosphor wheel has a plurality of color segments and rotates at a period so that each of the color segments sequentially receives the excitation light to generate a color light. The driving circuit is electrically connected to the excitation light source and the phosphor wheel. The driving circuit is configured to provide a driving current to the excitation light source, and changes the driving current in accordance with each of the color segments receiving the excitation light so as to adjust an energy conversion efficiency of each of the color segments for generating the color light.

This application claims priority based on Taiwan Patent Application No. 100139497 filed on Oct. 31, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a light emitting module and a display device comprising the same. More particularly, the light emitting module of the present invention changes a driving current supplied to an excitation light source in accordance with a plurality of color segments of a phosphor wheel so as to adjust an energy conversion efficiency of each of the color segments that generates a color light when receiving the excitation light.

2. Descriptions of the Related Art

With the rapid development of lighting devices and display devices, products that use an excitation light source (e.g., a light emitting diode (LED) or a laser diode) to generate an excitation light and use phosphors of different colors to transform the energy (or wavelength) of the excitation light into light of different colors have become increasingly popularized. For example, in all projectors currently available in the market, a constant driving power (or driving voltage or driving current) is used to generate an excitation light for illuminating phosphors of different colors on a phosphor wheel sequentially to generate light of different colors. However, the phosphors of some colors do not have positively correlated linear energy conversion characteristics. Furthermore, phosphors of different colors have different energy conversion characteristics, so this makes it difficult for phosphors of different colors to achieve the optimal energy conversion efficiency.

As shown in FIG. 1, the graphs of relative energy versus driving power of a yellow phosphor, a green phosphor and a red phosphor do not present positively correlated linear relationships. The relative energy refers to the energy of a color light generated by an excitation light after being transformed by a phosphor. Before the driving power increases to point A, the relative energy values of the phosphors of the three colors all increase with the driving power to present positively correlated linear relationships. However, after the driving power increases beyond point A, the relative energy value of the red phosphor begins to decrease to result in a negatively correlated relationship, which degrades the energy conversion efficiency of the red phosphor. Similarly, after the driving power increases beyond point B, the relative energy value of the yellow phosphor also begins to decrease, which also degrades the energy conversion efficiency of the yellow phosphor.

In other words, because conventional lighting devices and display devices use a constant driving power to generate an excitation light for illuminating phosphors of different colors, it is difficult to achieve optimal energy conversion efficiency. Consequently, this makes it difficult to provide optimal dynamic control and output performances in response to different operating modes or image conditions. Furthermore, to achieve different color performances or to satisfy different requirements of the image conditions, software must be utilized for signal control in all of the conventional lighting devices and display devices, but this often makes it difficult to obtain optimal efficiency.

Accordingly, an urgent need exists to improve the way of driving excitation light sources of lighting devices and display devices to manage the energy conversion efficiency of phosphors of different colors so that optimal dynamic control and output performances can be obtained under different operating modes or different image conditions.

### SUMMARY OF THE INVENTION

The primary objective of the present invention is to provide a light emitting module and a display device comprising the same. The light emitting module of the present invention comprises an excitation light source and a phosphor wheel. The phosphor wheel has a plurality of color segments. As the phosphor wheel rotates, each of the color segments is illuminated by the excitation light source periodically to generate a color light corresponding to the color segment. By dynamically adjusting a driving current supplied to the excitation light source, the light emitting module of the present invention can control an energy conversion efficiency of each of the color segments in generating the color light, so a display device using the light emitting module as a light emitting source can provide optimal dynamic control and optimal output performances in response to different operating modes or image conditions.

To achieve the aforesaid objective, the present invention provides a light emitting module, which comprises an excitation light source, a phosphor wheel and a driving circuit. The excitation light source is configured to generate an excitation light. The phosphor wheel has a plurality of color segments and rotates at a period so that each of the color segments sequentially receives the excitation light to generate a color light. The driving circuit is electrically connected to the excitation light source and the phosphor wheel. The driving circuit is configured to provide a driving current to the excitation light source, and changes the driving current in accordance with each of the color segments receiving the excitation light so as to adjust an energy conversion efficiency of each of the color segments for generating the color light.

Furthermore, the present invention further provides a display device, which comprises a light emitting module. The light emitting module comprises an excitation light source, a phosphor wheel and a driving circuit. The excitation light source is configured to generate an excitation light. The phosphor wheel has a plurality of color segments and rotates at a period so that each of the color segments sequentially receives the excitation light to generate a color light. The driving circuit is electrically connected to the excitation light source and the phosphor wheel. The driving circuit is configured to provide a driving current to the excitation light source, and changes the driving current in accordance with each of the color segments receiving the excitation light so as to adjust an energy conversion efficiency of each of the color segments for generating the color light.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates nonlinear relationships between the relative energy and driving power of phosphors;

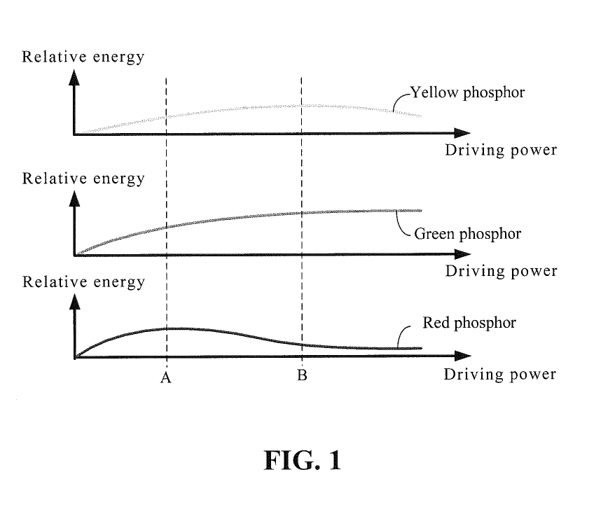

FIG. 2 is a schematic view of a light emitting module 1 according to a first embodiment of the present invention, in which a phosphor wheel 13 is of a transmissive type;

FIG. 3 is a schematic view of the phosphor wheel 13 according to the first embodiment of the present invention;

FIG. 4 is a schematic view of the light emitting module 1 according to the first embodiment of the present invention, in which the phosphor wheel 13 is of a reflective type;

FIG. 5 illustrates how the driving current 106 changes with the rotation of the phosphor wheel 13;

FIG. 6 is a schematic view of a light emitting module 1 according to the second embodiment of the present invention;

FIG. 7 illustrates how the driving current 106 changes with the rotation of the phosphor wheel 13 in different display modes;

FIG. 8 is a schematic view of a display device 7 according to the third embodiment of the present invention; and

FIG. 9 illustrates how a driving power ratio changes with a color gradation value 108 generated according to real-time image data 702.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, the description of these embodiments is only for the purpose of illustration rather than limitation. It should be appreciated that in the following embodiments and attached drawings, elements unrelated to the present invention are omitted from depiction; and dimensional relationships among individual elements in the attached drawings are illustrated only for the ease of understanding, but not to limit the actual scale.

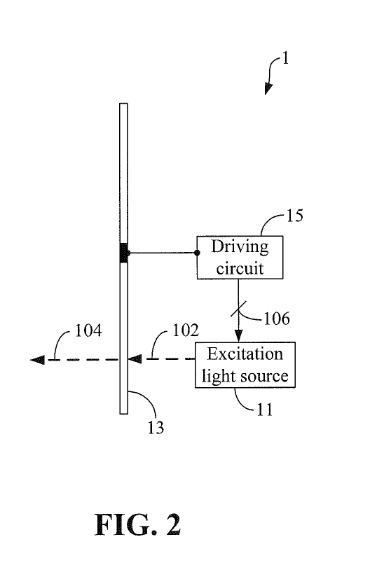

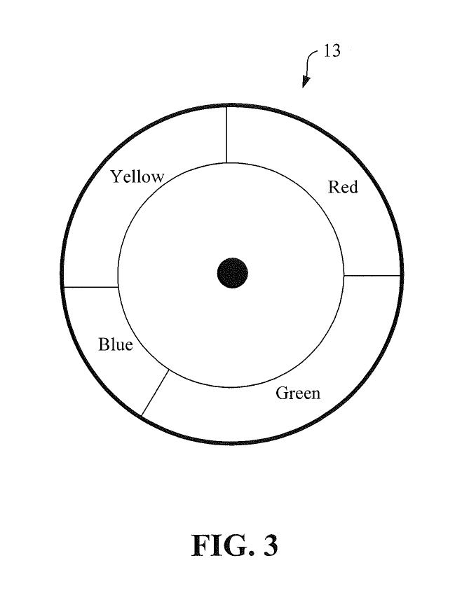

FIG. 2 is a schematic view of a light emitting module 1 according to a first embodiment of the present invention. The light emitting module 1 comprises an excitation light source 11, a phosphor wheel 13 and a driving circuit 15. The excitation light source 11 may be a light emitting diode (LED) or a laser diode, and is configured to generate an excitation light 102 of a specific wave band. The phosphor wheel 13 has a plurality of color segments and rotates at a period. As shown in FIG. 3, in this embodiment, the color segments of the phosphor wheel 13 are formed by a yellow phosphor, a red phosphor, a green phosphor and a blue phosphor respectively. However, in other embodiments, the phosphor wheel 13 may comprise phosphors of a different number and different colors.

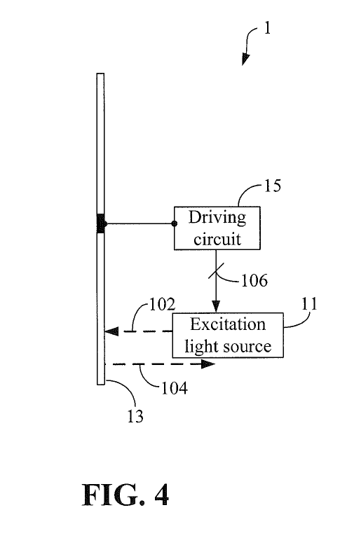

As the phosphor wheel 13 rotates, each of the color segments will sequentially receive the excitation light 102 to generate a color light 104. As shown in FIG. 2, the phosphor wheel 13 is of a transmissive design, and is formed by coating a yellow phosphor, a red phosphor, a green phosphor and a blue phosphor on a transparent substrate. The color light 104 (i.e., a yellow light, a red light, a green light or a blue light) is generated by the excitation light 102 transmitting through one of the color segments on the phosphor wheel 13. Furthermore, as shown in FIG. 4, the phosphor wheel 13 may also be of a reflective design, and is formed by coating a yellow phosphor, a red phosphor, a green phosphor and a blue phosphor on a metal substrate or an optically reflective substrate. Therefore, the color light 104 may also be generated by the excitation light 102 reflected from a plurality of color segments on the phosphor wheel 13. In other embodiments, the excitation light 102 itself generated by the excitation light source 11 may already be a color light (e.g., a blue light), in which case a color segment corresponding to the blue phosphor can be omitted from the phosphor wheel 13.

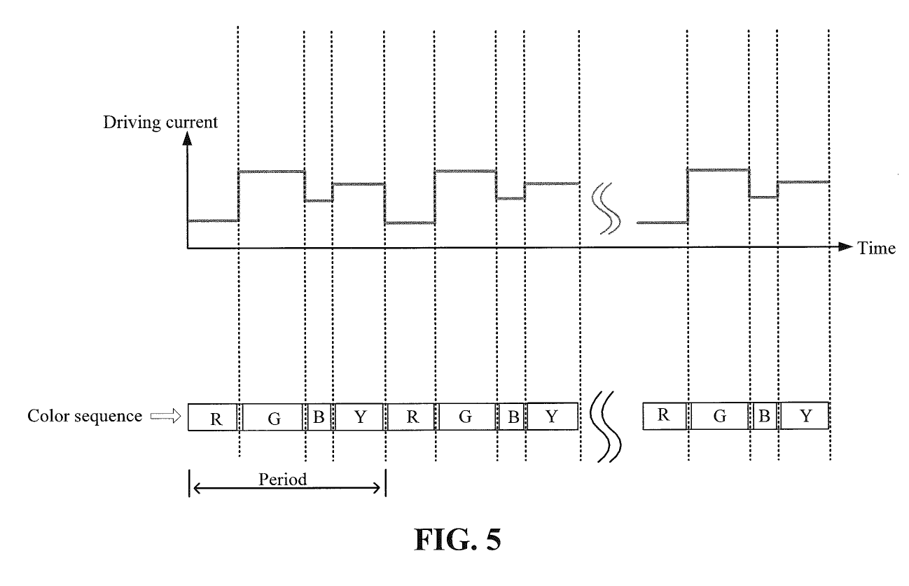

The driving circuit 15 is electrically connected to the excitation light source 11 and the phosphor wheel 13, and is configured to provide a driving current 106 to the excitation light source 11 and provide a current necessary for the operation of the phosphor wheel 13. The driving circuit 15 dynamically changes the driving current 106 with the rotation of the phosphor wheel 13 so as to adjust an energy conversion efficiency of the phosphor of each color. Specifically, with reference to FIG. 5, as the phosphor wheel 13 rotates at a period, each of the color segments (i.e., the red (R) phosphor, the green (G) phosphor, the blue (B) phosphor and the yellow (Y) phosphor) on the phosphor wheel 13 sequentially receives the excitation light 102, and the driving circuit 15 changes the driving current 106 in accordance with each of the color segments receiving the excitation light 102. Thus, by dynamically changing the driving current 106, the present invention can adjust the energy conversion efficiency of each color segment in generating the color light 104. In this way, optimal energy conversion efficiency can be achieved, unlike the prior art due to the use of a constant driving power to generate the excitation light for illuminating phosphors of different colors.

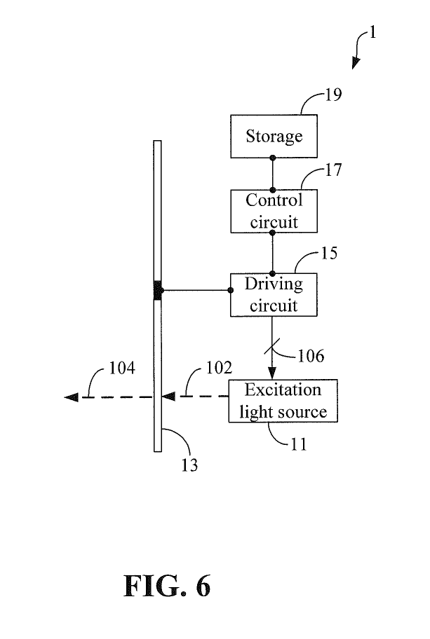

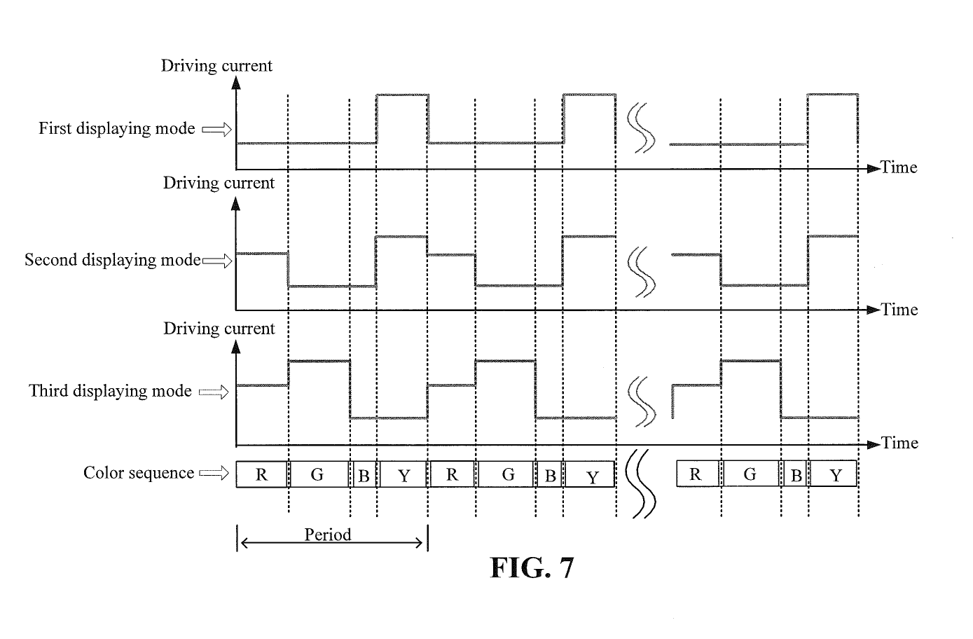

A second embodiment of the present invention is shown in FIG. 6. In this embodiment, the light emitting module 1 further comprises a storage 19 and a control circuit 17. The storage 19 stores a working parameter of each of a plurality of working modes. The control circuit 17 is electrically connected to the storage 19 and the driving circuit 15. Specifically, the control circuit 17 is configured to activate either of the working modes and control the driving circuit 15 in accordance with the working parameter of each of the working modes to change the driving current 106 corresponding to the color segments on the phosphor wheel 13. For example, FIG. 7 illustrates the changes of the driving current 106 with respect to the color segments (i.e., the red phosphor, the green phosphor, the blue phosphor and the yellow phosphor) in different display modes. In this embodiment, a first displaying mode is a bright mode, and when the control circuit 17 activates the first displaying mode, the control circuit 17 reads the working parameter corresponding to the first displaying mode from the storage 19 so that when the excitation light 102 illuminates the yellow color segment (i.e., the yellow phosphor), the driving circuit 15 provides a larger driving current 106 to the excitation light source 11 to generate an excitation light 102 with greater energy.

Similarly, a second display mode is a movie mode and a third displaying mode is a television mode. When the second displaying mode or the third displaying mode is activated, the control circuit 17 also reads the working parameter corresponding to the second displaying mode or the third displaying mode respectively to enable the driving circuit 15 to change the driving current 106 correspondingly. It shall be appreciated that in other embodiments, the storage 19 may store the working parameter of one or more display modes, so the number of the displaying modes is not intended to limit the present invention. Furthermore, in this embodiment, as shown in FIG. 4, the phosphor wheel 13 may also be of a reflective design, in which case the color light 104 is generated by the excitation light 102 reflected from a plurality of color segments on the phosphor wheel 13.

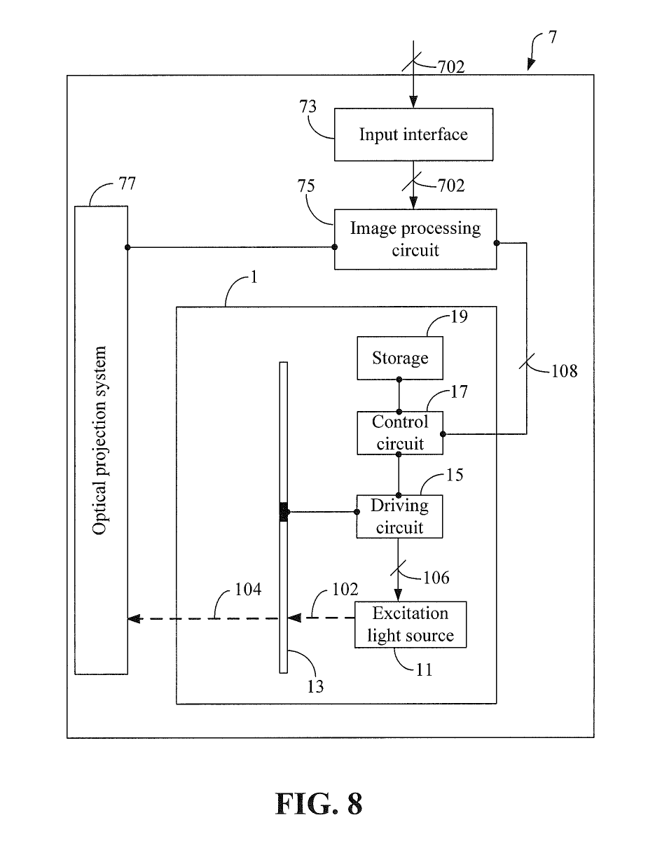

Next, referring to FIG. 8, there is shown a schematic view of a display device 7 according to a third embodiment of the present invention. The display device 7 comprises a light emitting module 1, an input interface 73, an image processing circuit 75 and an optical projection system 77. The light emitting module 1 is just the same as that of the second embodiment and can execute all the operations and functions described in the second embodiment, so no further description will be made again herein. In this embodiment, the display device 7 is a projector. However, in other embodiments, the display device 7 may be any display device or lighting device (e.g., a light box) adopting the light emitting module 1 as a light source.

The input interface 73 may be a video graphics array (VGA) terminal (or termed as a D-Sub interface), a high-definition multimedia interface or some other image input interface. The input interface 73 is configured to receive real-time image data 702 and transmit the real-time image data 702 to the image processing circuit 75. The image processing circuit 75 is electrically connected to the control circuit 17 of the light emitting module 1, and is configured to generate a color gradation value 108 according to the real-time image data 702 and transmit the color gradation value 108 to the control circuit 17 of the light emitting module 1. The image processing circuit 75 is further configured to project an image corresponding to the real-time image data 702 through the optical projection system 77 according to the real-time image data 702.

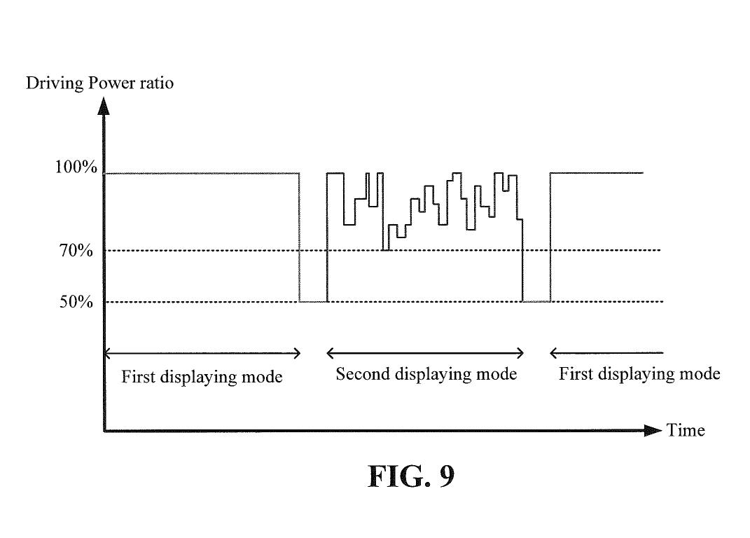

In this embodiment, the control circuit 17 further controls the driving circuit 15 according to the color gradation value 108 so as to adjust an average value of the driving current 106, that is, to adjust the driving currents 106 corresponding to all of the color segments in an equal proportion. In other words, if the average value of the driving current 106 is represented by a driving power ratio (i.e., a ratio of the driving power to a maximum value) instead, then the control circuit 17 will control an overall power outputted by the driving circuit 15 according to the color gradation value 108. For example, as shown in FIG. 9, the driving power ratio changes with the color gradation value 108 generated according to the real-time image data 702 when the second displaying mode (i.e., the movie mode) is activated by the control circuit 17. In this way, even when the real-time image data 702 is an image of a dark scene, the image projected by the optical projection system 77 can be made darker by decreasing the overall driving power. Conversely, even when the real-time image data 702 is an image of a bright scene, the image projected by the optical projection system 77 can be made brighter by increasing the overall driving power. Therefore, by adjusting the driving power in real time according to the real-time image data 702, a dynamic contrast ratio can be further achieved for the images projected.

According to the above descriptions, by dynamically changing the driving current provided to the excitation light source, the light emitting module and the display device of the present invention can control the energy conversion efficiency of the phosphors of different colors so as to provide optimal dynamic control and optimal output performances according to different operating modes or image conditions.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light emitting module, comprising:
an excitation light source, being configured to generate an excitation light;
a phosphor wheel, having a plurality of color segments and rotating at a period so that each of the color segments sequentially receives the excitation light to generate a color light; and
a driving circuit, being electrically connected to the excitation light source and the phosphor wheel, and being configured to provide a driving current to the excitation light source and change the driving current in accordance with each of the color segments receiving the excitation light so as to adjust an energy conversion efficiency of each of the color segments for generating the color light.

2. The light emitting module of claim 1, wherein the excitation light source is one of a light emitting diode or a laser diode.

3. The light emitting module of claim 1, wherein the color lights are generated by the excitation light penetrating through the color segments or by the excitation light being reflected from the color segments.

4. The light emitting module of claim 1, further comprising a storage and a control circuit, wherein the storage stores a working parameter of each of a plurality of working modes, and the control circuit is electrically connected to the storage and the driving circuit and is configured to activate one of the working modes and control the driving circuit to change the driving current corresponding to the color segments according to the working parameter of each of the working modes.

5. A display device, comprising:
a light emitting module, comprising:
an excitation light source, being configured to generate an excitation light;
a phosphor wheel, having a plurality of color segments and rotating at a period so that each of the color segments sequentially receives the excitation light to generate a color light; and
a driving circuit, being electrically connected to the excitation light source and the phosphor wheel, and being configured to provide a driving current to the excitation light source and change the driving current in accordance with each of the color segments receiving the excitation light so as to adjust an energy conversion efficiency of each of the color segments for generating the color light.

6. The display device of claim 5, wherein the excitation light source is one of a light emitting diode or a laser diode.

7. The display device of claim 5, wherein the color lights are generated by the excitation light penetrating through the color segments or by the excitation light being reflected from the color segments.

8. The display device of claim 5, wherein the light emitting module further comprises a storage and a control circuit, the storage stores a working parameter of each of a plurality of working modes, and the control circuit is electrically connected to the storage and the driving circuit and is configured to activate one of the working modes and control the driving circuit to change the driving current corresponding to the color segments according to the working parameter of each of the working modes.

9. The display device of claim 5, further comprising an image processing circuit, wherein the light emitting module further comprises a control circuit electrically connected to the image processing circuit, the image processing circuit is configured to receive a real-time image data, generate a color gradation value according to the real-time image data and transmit the color gradation value to the control circuit, and the control circuit controls the driving circuit according to the color gradation value so as to adjust an average value of the driving current.

10. The display device of claim 5, wherein the display device is a projector.
